(19) United States
(12) Patent Application Publication
(10) Pub. No.: US 2026/0159143 A1
(43) Pub. Date: Jun. 11, 2026

(54) INFORMATION PROCESSING APPARATUS, INFORMATION PROCESSING METHOD, AND STORAGE MEDIUM

(71) Applicant: NEC Corporation, Tokyo (JP)

(72) Inventors: Takuma IKEDA, Tokyo (JP); Shumpei KUBOSAWA, Tokyo (JP)

(73) Assignee: NEC Corporation, Tokyo (JP)

(21) Appl. No.: 19/399,748

(22) Filed: Nov. 25, 2025

(30) Foreign Application Priority Data
Dec. 9, 2024 (JP) 2024-214532

(51) Int. Cl. B61L 27/12; G06Q 10/04

(52) U.S. Cl. CPC B61L 27/12; G06Q 10/04

(57) ABSTRACT

An information processing apparatus of the present disclosure includes: a constructing unit that constructs association information in which a constraint on a number of train cars at a station and between stations is associated with station information representing a station at each time, based on a train schedule; and a creating unit that creates a train car operation plan in which a train formation operated at a station and between stations in the train schedule is defined in such a manner as to satisfy the constraint, based on the association information.

### INCORPORATION BY REFERENCE

This application is based upon and claims the benefit of priority from Japanese patent application No. 2024-214532, filed on Dec. 9, 2024, the disclosure of which is incorporated herein in its entirety by reference.

### TECHNICAL FIELD

The present disclosure relates to an information processing apparatus, an information processing method, and a storage medium.

### BACKGROUND ART

Patent Literature 1 describes creating a train car operation plan based on a train schedule. To be specific, in Patent Literature 1, a train car operation plan is created by indicating each train in a train schedule as a node, showing a network connecting the trains by arcs, and searching for a train route.

Patent Literature 1: Japanese Patent Publication No. 3989713

### SUMMARY

However, in Patent Literature 1 shown above, there is a problem that it takes time to search for a train route and it takes time to create an appropriate train car operation plan.

Accordingly, an object of the present disclosure is to solve the abovementioned problem that it takes time to create an appropriate train car operation plan.

An information processing apparatus as an aspect of the present disclosure includes: a constructing unit that constructs association information in which a constraint on a number of train cars at a station and between stations is associated with station information representing a station at each time, based on a train schedule; and a creating unit that creates a train car operation plan in which a train formation operated at a station and between stations in the train schedule is defined in such a manner as to satisfy the constraint, based on the association information.

Further, an information processing method as an aspect of the present disclosure includes: constructing association information in which a constraint on a number of train cars at a station and between stations is associated with station information representing a station at each time, based on a train schedule; and creating a train car operation plan in which a train formation operated at a station and between stations in the train schedule is defined in such a manner as to satisfy the constraint, based on the association information.

Further, a program as an aspect of the present disclosure includes instructions for causing an information processing apparatus to execute processes to: construct association information in which a constraint on a number of train cars at a station and between stations is associated with station information representing a station at each time, based on a train schedule; and create a train car operation plan in which a train formation operated at a station and between stations in the train schedule is defined in such a manner as to satisfy the constraint, based on the association information.

With the configurations as described above, the present disclosure can reduce the time required for creating an appropriate train car operation plan.

### BRIEF DESCRIPTION OF THE DRAWINGS

FIG. 1 is a block diagram showing an example of a configuration of an information processing apparatus according to the present disclosure;

FIG. 2 is a flowchart showing an example of processing operation of the information processing apparatus according to the present disclosure;

FIG. 3 is a diagram showing an example of a state of processing by the information processing apparatus according to the present disclosure;

FIG. 4 is a diagram showing an example of a state of processing by the information processing apparatus according to the present disclosure;

FIG. 5 is a block diagram showing an example of a hardware configuration of an information processing apparatus according to the present disclosure; and

FIG. 6 is a block diagram showing an example of a configuration of the information processing apparatus according to the present disclosure.

### EXAMPLE EMBODIMENT

### First Example Embodiment

A first example embodiment of the present disclosure will be described with reference to the drawings. The drawings may relate to any example embodiment.

An information processing apparatus 10 in the present disclosure is used to create a train car operation plan based on a train schedule, as an example. In particular, in this example embodiment, the information processing apparatus 10 creates a train car operation plan in such a manner as to satisfy a constraint on the number of train cars at stations and between stations. At this time, in this example embodiment, the information processing apparatus 10 further creates a train car operation plan in such a manner as to minimize a train car cost responsive to the operator's request and the like. However, the present disclosure is not necessarily limited to considering the train car cost, and it is sufficient to create a train car operation plan in such a manner as to satisfy the constraint. In the present disclosure, a composition including a single train car or a plurality of train cars will be referred to as a “train formation”, and a train formation operated between stations will be referred to as a “train”.

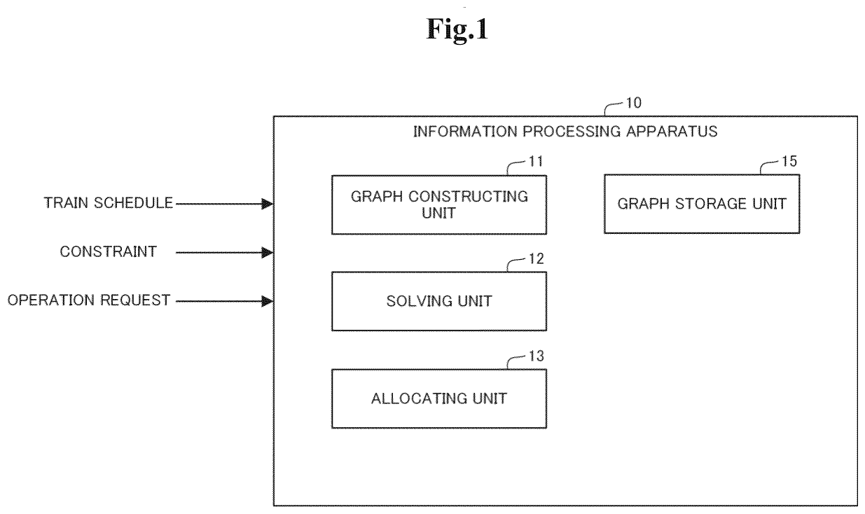

Below, a configuration and operation of the information processing apparatus 10 in this example embodiment will be described. The information processing apparatus 10 is configured with one or a plurality of information processing apparatuses each including an arithmetic logic unit and a memory unit. Then, as shown in FIG. 1, the information processing apparatus 10 includes a graph constructing unit 11, a solving unit 12, and an allocating unit 13. The respective functions of the graph constructing unit 11, the solving unit 12 and the allocating unit 13 can be implemented by execution of a program for implementing the respective functions stored in the memory unit by the arithmetic logic unit. Moreover, the information processing apparatus 10 includes a graph storage unit 15 formed with the memory unit.

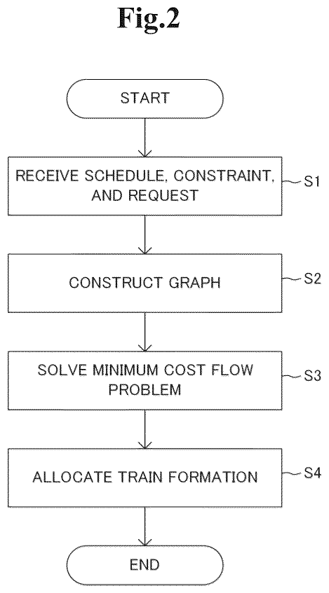

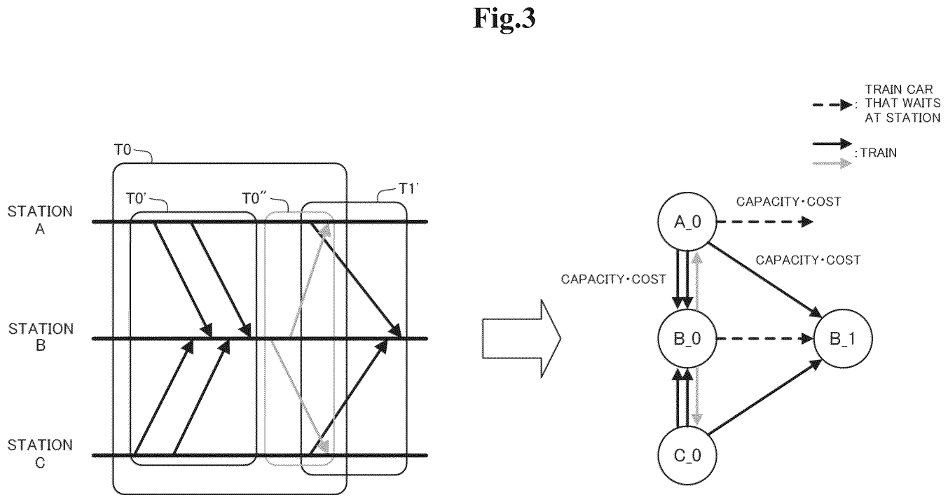

The graph constructing unit 11 (constructing unit) first receives a train schedule, a constraint, and an operation request (step S1 of FIG. 2). The train schedule is information represented by a diagram expressing a train operation plan and, for example, is represented as in a left view of FIG. 3. To be specific, the train schedule includes stations and departure/arrival time points (departure time point and arrival time point) from and at the stations of each train, and is configured in such a manner that required time between the stations of each train and required time at each of the stations can be understood. Moreover, the train schedule may include other information such as the kind of a train car.

The constraint is information representing a constraint on train cars at stations and on tracks between the stations. For example, the constraint is information such as the number of train cars that can wait at each station and the number of train car that can stop at night, and information such as the number of train cars that can enter each track. The constraint is not limited to the constraint on the number of train cars at stations and between stations, and may include a constraint on the type of a train car.

The operation request is information representing a request regarding trains from the operation personnel. For example, the operation request is information such as the maximum number of train cars, the desired number of train cars and the minimum number of train cars for each section between stations and for each time. The operation request may be the number of train cars requested for each section between stations regardless of time, and may include a request regarding the type of a train car between the stations.

Then, by using the train schedule, the constraint, and the operation request, the graph constructing unit 11 constructs a graph in which station information representing a station for each time period is defined as a node and information representing the movement of a train car between stations is associated as an edge with the node (step S2 of FIG. 2). It can be also said that the edge represents at least one of a train between stations or a train formation that is waiting (or staying) at a station across time periods (hereinafter referred to as a “waiting train formation”). The edge may be associated with a capacity that represents constraints such as the number of train cars of a train formation that can wait at a station, the number of train cars of a train between stations, and the like. As an example, the graph constructing unit 11 constructs a graph as shown in a right view of FIG. 3 based on the train schedule shown in the left view of FIG. 3 and the abovementioned constraint and operation request. Here, an example of constructing the graph will be described with reference to FIG. 3.

First, in the train schedule of the left view of FIG. 3, trains indicated by arrows in reference sign T0′ represent trains arriving at Station B (hereinafter referred to as “arrival train”), and trains indicated by arrows in reference sign T0″ represent trains departing from Station B (hereinafter referred to as “departure train”). Moreover, trains indicated by arrows in reference sign T1′ represent arrival trains at Station B. In such a case, each station relating to “arrival train T0′ at Station B→departure train T0 from Station B” is expressed as one node at time T0. Consequently, as shown in the right view of FIG. 3, Stations A, B and C at time T0 are expressed as nodes A_0, B_0 and C_0, respectively, and Station B at time T1 is expressed as a node B_1. In addition, an edge indicated by an arrow corresponding to each operated train is connected to each node corresponding to each station at each time. To be specific, in a case where there is a train running between stations at each time, nodes corresponding to the respective stations at each time are connected by an edge indicated by an arrow corresponding to the running train. Moreover, in a case where a train formation can wait at each station at each time, to a node corresponding to each station at each time, an edge indicated by a dotted arrow corresponding to waiting of the train formation at the station is connected.

Then, the graph constructing unit 11 sets, for the edge connected to the nodes as described above, a capacity representing the constraint on the number of train cars at the stations and between the stations and the cost per train car, based on the constraint and the operation request.

The capacity represents a constraint at the time of creating a train car plan. For example, the capacity is a value set based on the constraint, and in a case where an edge represents a train running between stations, the maximum number of train cars that can run between the stations is set. In this case, the capacity may represent the maximum number of train cars determined based on the number of tracks and the like. For example, in a case where an edge represents waiting of a train formation at a station, the maximum number of train cars that can wait at the station is set as the capacity. In this case, the capacity may represent a physical constraint such as the number of platforms for causing a train formation to wait at a station. The capacity may represent a constraint based on an operation schedule. In this case, for example, the capacity may represent the maximum number of train cars that can be operated in a specific time period, based on departure/arrival time set in the time period or congestion of a train schedule. The capacity may represent a safety or operational constraint. In this case, the capacity may be, for example, a value set based on a safety criterion for ensuring safe train operation on tracks and at stations. The capacity may represent a constraint that allows holding at a station from the time of the last train of a day to the time of the first train of the next day. In this case, the capacity may represent the number of train cars that can be held in a train car storage of a station, in addition to the number of platforms of a station, for example.

The cost is set for the edge and represents a numerical value on the evaluation of train car operation. For example, the cost represents a cost required for a train car running between stations or a cost required for a train car waiting at a station. At this time, the cost is set to a smaller value as it is desired more that the operation of train cars at stations and between stations is desired based on an operation request. As an example, between stations, in a section where it is desired for a train car to run, the cost is set to a smaller value, and in some cases, set to a negative value. Therefore, in a case where, in a time period or between stations, a large number of passengers are expected and a large number of train cars is desired in an operation request, the cost is set to a small value. In addition, in a case where a train car waits at a station, when the use of a number of train cars is desired after that, the cost is set to a small value, whereas when the use of train cars is not desired or the number of train cars that can wait is limited after that, the cost is set to a large value.

Further, the cost may represent an expense required for operating trains. In this case, the cost represents economic expenses such as electrical charges, maintenance costs, and fuel expenses associated with operating trains. The cost may represent an expense based on demand for trains. In this case, the cost is set, for example, in accordance with passenger demand during a specific time period or section. For example, when the demand is high, allocation of trains is prioritized, so that the cost is set low, whereas when the demand is low, the cost is set high. The cost may represent an expense based on the characteristics of train cars. In this case, for example, the cost is set higher when maintenance is required at a higher frequency due to operation, and the cost is set lower when maintenance is required at a lower frequency. The cost may be set in accordance with an intention to operate trains. In this case, for example, the cost is set low when there is a sudden surge in demand such as during an event, and the cost is set high under normal circumstances.

As described above, as shown in the right view of FIG. 3, the graph constructing unit 11 constructs a graph in which nodes representing stations at each time are connected by an edge representing a constraint on the number of train cars of train formations waiting at the stations and the number of train cars of a train between the stations and a cost for the train cars. At this time, the graph constructing unit 11 may construct the graph by setting nodes representing virtual start and end points at the beginning and end of the day so as to represent a train schedule for the entire day by a group of graphs, and may divide the train schedule into given time periods to construct a group of graphs for each time period. Then, the graph constructing unit 11 stores the constructed graph into the graph storage unit 15.

The solving unit 12 (creating unit) calculates the number of operated train cars in such a manner as to satisfy the constraints set at stations and between stations by using the graph constructed as described above. At this time, the solving unit 12 calculates the number of operated train cars in such a manner as to minimize the cost in the entire group of graphs. That is to say, the solving unit 12 solves the minimum cost flow problem in the graph (step S3 of FIG. 2).

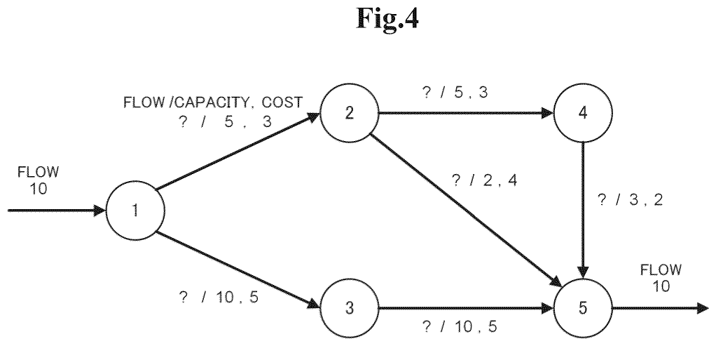

Here, an example of a graph constructed by the graph constructing unit 11 and solved by the solving unit 12 is shown in FIG. 4. In this graph, Node 1 is the start point, Node 5 is the end point, and the respective nodes (1 to 5) represent stations at each time. Then, an edge corresponding to an operated train is connected to each node, and moreover, the abovementioned “capacity” and “cost” are set for each edge. At this time, “flow” shown in FIG. 4 represents “number of train cars” that can be operated. Therefore, in the example of FIG. 4, a problem of minimizing the cost in the entire graph and allocating “number of train cars=10” while satisfying a capacity that is the constraint set for each edge is solved. Specifically, the solving unit 12 calculates the allocation of the number of train cars (indicated by “?” in FIG. 4) in such a manner that it does not exceed the maximum number of train cars that is “capacity” and the total of values obtained by multiplying “cost” by the number of train cars is minimized in each edge.

As an example, “capacity: 5” and “cost: 3” are set for an edge connecting Node 1 and Node 2. Therefore, regarding the edge, the number of train cars, which is “flow”, becomes “5” or less, and the cost of “number of train cars×3 (cost)” is calculated. Then, regarding all the edges, the calculation of “number of train cars×cost” is performed likewise without “flow” exceeding the number of train cars of “capacity”, and allocation of the number of train cars that is “flow” for each edge is calculated so as to minimize the total cost.

The allocating unit 13 (creating unit) allocates a train formation to each train in a train schedule in such a manner that the number of train cars calculated by the solving unit 12 is achieved as described above (step S4 of FIG. 2). That is to say, the number of train cars of each train operated in the train schedule is set to the found number of train cars. Then, as a result of allocating the train formation to each train as described above, the allocating unit 13 creates and outputs a train car operation plan including a series of trains run by each train formation.

Furthermore, the allocating unit 13 may control to configure a train formation of each train in accordance with the found number of train cars. For example, the allocating unit 13 may allocate a plurality of train formations to the same train so that the total number of train cars is equal to the found number of train cars, thereby controlling coupling and decoupling of a train formation configuring a train in a train car garage and tracks at a station in accordance with the found number of train cars.

As described above, according to this example embodiment, by creating a graph in which stations at each time are nodes and the constraint and cost of train cars are edges, it is possible to search for a train formation in such a manner as to minimize the cost while satisfying the constraint. Consequently, it is possible to reduce the time required for the search, and consequently, it is possible to reduce the time required for creating an appropriate train car operation plan satisfying the constraint.

Here, in the present disclosure, the graph constructing unit 11 is not necessarily limited to constructing a graph. For example, the graph constructing unit 11 may construct association information of data structure in which the constraints on the number of train cars waiting at stations and the number of train cars of trains between stations and the costs are associated with station information representing stations at each time. Then, the solving unit 12 finds solution for the association information so as to satisfy the constraints, thereby calculating allocation of the number of train cars in the same manner as described above.

Further, in the present disclosure, it is not necessarily limited to setting a cost in a graph (association information). For example, the graph constructing unit 11 constructs association information of data structure in which the constraints on the number of train cars waiting at stations and the number of train cars of trains between stations are associated with station information representing stations at each time, and the solving unit 12 finds solution for the association information so as to satisfy the constraints on the number of train cars at stations and between stations, thereby calculating allocation of the number of train cars in the same manner as described above.

### Second Example Embodiment

Next, a second example embodiment of the present disclosure will be described with reference to the drawings. In this example embodiment, the overview of the information processing apparatus and so forth described in the above example embodiment is shown. The drawings may relate to any of the example embodiments.

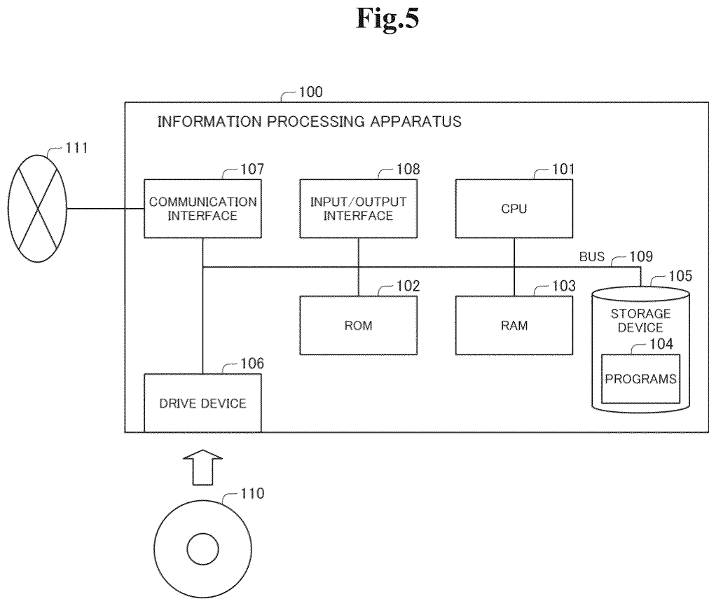

First, a hardware configuration of an information processing apparatus 100 in the present disclosure will be described. The information processing apparatus 100 is configured with a general information processing apparatus, and as an example, as shown in FIG. 5, has the following hardware configuration including:
a CPU (Central Processing Unit) 101 (arithmetic logic unit);
a ROM (Read Only Memory) 102 (memory unit);
a RAM (Random Access Memory) 103 (memory unit);
programs 104 loaded into the RAM 103;
a storage device 105 storing the programs 104;
a drive device 106 that performs reading from and writing into a storage medium 110 external to the information processing apparatus;
a communication interface 107 connected to a communication network 111 external to the information processing apparatus;
an input/output interface 108 that performs input/output of data; and
a bus 109 connecting the components.

FIG. 5 shows an example of the hardware configuration of the information processing apparatus serving as the information processing apparatus 100, and the hardware configuration of the information processing apparatus is not limited to the abovementioned case. For example, the information processing apparatus may be configured with part of the abovementioned configuration, such as not having the drive device 406. Moreover, the information processing apparatus may use a GPU (Graphic Processing Unit), a DSP (Digital Signal Processor), an MPU (Micro Processing Unit), an FPU (Floating point number Processing Unit), a PPU (Physics Processing Unit), a TPU (Tensor Processing Unit), a quantum processor, a microcontroller, or a combination thereof, instead of the abovementioned CPU.

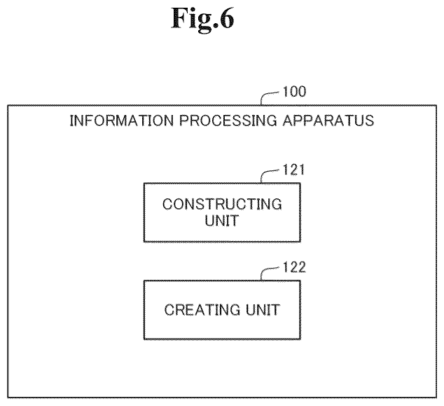

Then, the information processing apparatus 100 can construct and include a constructing unit 121 and a creating unit 122 shown in FIG. 6 by acquisition and execution of the programs 104 by the CPU 101. The programs 104 are, for example, stored in advance in the storage device 105 or the ROM 102, and are loaded into the RAM 103 and executed by the CPU 101 as necessary. In addition, the programs 104 may be provided to the CPU 101 via the communication network 111, or the programs may be stored in advance in the storage medium 110 and read out by the drive device 106 and provided to the CPU 101. However, the constructing unit 121 and the creating unit 122 described above may be constructed using dedicated electronic circuits for implementing such means.

The constructing unit 121 constructs association information in which constraints on the number of train cars of train formations waiting at stations and the number of train cars of trains between stations are associated with station information representing stations at each time, based on a train schedule. The creating unit 122 creates a train car operation plan that defines a train formation operated at stations and between stations in the train schedule so as to satisfy the constraints, based on the association information.

With the configuration as described above, the present disclosure enables construction of association information in which constraints on the number of train cars are associated with information of stations at each time, and creation of a train car operation plan that satisfies the constraints on the number of train cars based on the association information. As a result, it is possible to reduce the time required for creating an appropriate train car operation plan satisfying the constraints.

At least one or more functions of the functions of the constructing unit 121 and the creating unit 122 described above may be executed by an information processing apparatus installed and connected anywhere on the network, that is, may be executed by so-called cloud computing.

Further, the abovementioned program can be stored using various types of non-transitory computer-readable mediums and provided to a computer. The non-transitory computer-readable medium includes various types of tangible storage mediums. Examples of non-transitory computer-readable medium include magnetic recording medium (e.g., flexible disk, magnetic tape, hard disk drive), magneto-optical recording medium (e.g., magneto-optical disk), CD-ROM (Read Only Memory), CD-R, CD-R/W, and semiconductor memory (e.g., mask ROM, PROM (Programmable ROM), EPROM (Erasable PROM), flash ROM, RAM (Random Access Memory)). In addition, the program may be provided to a computer by various types of transitory computer-readable mediums. Examples of transitory computer-readable mediums include electrical signals, optical signals, and electromagnetic waves. The temporary computer-readable medium may provide a program to the computer via a wired communication channel such as an electric wire and an optical fiber, or via a wireless communication channel.

Although the present disclosure has been described above with reference to the example embodiments, the present disclosure is not limited to the example embodiments described above. The configuration and details of the present disclosure can be changed in a variety of ways that those skilled in the art can understand within the scope of the present disclosure. Then, each of the example embodiments described above can be combined with the other example embodiment as necessary.

### SUPPLEMENTARY NOTES

The whole or part of the example embodiments disclosed above can be described as the following supplementary notes. Hereinafter, the overview of a calculation apparatus and so forth in the present disclosure will be described. However, the present disclosure is not limited to the following configurations.

All or some of the configurations described in Supplementary Notes 2 to 8 dependent on Supplementary Note 1 below and the functions by such configurations may be dependent on other Supplementary Notes 9 and 10 by the same dependence as Supplementary Notes 2 to 8. Furthermore, not limited to Supplementary Notes 1, 9 and 10, within the scope of the example embodiments described above, all or some of the configurations described as supplementary notes and functions by such configurations may be dependent on hardware, software, various recording means for recording software, or system.

### Supplementary Note 1

An information processing apparatus comprising:
at least one memory storing processing instructions; and
at least one processor configured to execute the processing instructions to:
construct association information in which a constraint on a number of train cars at a station and between stations is associated with station information representing a station at each time, based on a train schedule; and
create a train car operation plan in which a train formation operated at a station and between stations in the train schedule is defined in such a manner as to satisfy the constraint, based on the association information.

### Supplementary Note 2

The information processing apparatus according to supplementary note 1, wherein the at least one processor is configured to execute the processing instructions to
create a graph in which the station information is a node and an edge representing the constraint is connected to the node, as the association information.

### Supplementary Note 3

The information processing apparatus according to supplementary note 2, wherein the at least one processor is configured to execute the processing instructions to
create the graph in which a constraint on a number of train cars of a train formation waiting at a station and a number of train cars of a train moving between stations is connected as the edge to the node.

### Supplementary Note 4

The information processing apparatus according to supplementary note 1, wherein the at least one processor is configured to execute the processing instructions to
calculate a cost at a station and between stations responsive to a number of train cars operated at a station and between stations in the train schedule, based on the association information, and create the train car operation plan based on the calculated cost.

### Supplementary Note 5

The information processing apparatus according to supplementary note 4, wherein the at least one processor is configured to execute the processing instructions to
calculate a sum of costs at stations and between stations responsive to a number of train cars operated at stations and between stations, in a group of the association information, and create the train car operation plan in such a manner as to minimize the sum of the costs.

### Supplementary Note 6

The information processing apparatus according to supplementary note 5, wherein
the more a train car is desired to be operated at a station and between stations, the smaller value the cost is set to.

### Supplementary Note 7

The information processing apparatus according to supplementary note 4, wherein the at least one processor is configured to execute the processing instructions to
construct the association information in which the cost incurred for each train car due to operation at a station and between stations is associated with the station information.

### Supplementary Note 8

The information processing apparatus according to supplementary note 7, wherein the at least one processor is configured to execute the processing instructions to
receive an operation request concerning a train car between stations, and construct the association information in which the cost responsive to the operation request is associated with the station information.

### Supplementary Note 9

An information processing method comprising, by an information processing apparatus:
constructing association information in which a constraint on a number of train cars at a station and between stations is associated with station information representing a station at each time, based on a train schedule; and
creating a train car operation plan in which a train formation operated at a station and between stations in the train schedule is defined in such a manner as to satisfy the constraint, based on the association information.

### Supplementary Note 10

A program comprising instructions for causing an information processing apparatus to execute processes to:
construct association information in which a constraint on a number of train cars at a station and between stations is associated with station information representing a station at each time, based on a train schedule; and
create a train car operation plan in which a train formation operated at a station and between stations in the train schedule is defined in such a manner as to satisfy the constraint, based on the association information.

### REFERENCE SIGNS LIST

10 information processing apparatus
11 graph constructing unit
12 solving unit
13 allocating unit
15 graph storage unit
100 information processing apparatus
101 CPU
102 ROM
103 RAM
104 programs
105 storage device
106 drive device
107 communication interface
108 input/output interface
109 bus
110 storage medium
111 communication network
121 constructing unit
122 creating unit

1. An information processing apparatus comprising:
at least one memory storing processing instructions; and
at least one processor configured to execute the processing instructions to:
construct association information in which a constraint on a number of train cars at a station and between stations is associated with station information representing a station at each time, based on a train schedule; and
create a train car operation plan in which a train formation operated at a station and between stations in the train schedule is defined in such a manner as to satisfy the constraint, based on the association information.

2. The information processing apparatus according to claim 1, wherein the at least one processor is configured to execute the processing instructions to
create a graph in which the station information is a node and an edge representing the constraint is connected to the node, as the association information.

3. The information processing apparatus according to claim 2, wherein the at least one processor is configured to execute the processing instructions to
create the graph in which a constraint on a number of train cars of a train formation waiting at a station and a number of train cars of a train moving between stations is connected as the edge to the node.

4. The information processing apparatus according to claim 1, wherein the at least one processor is configured to execute the processing instructions to
calculate a cost at a station and between stations responsive to a number of train cars operated at a station and between stations in the train schedule, based on the association information, and create the train car operation plan based on the calculated cost.

5. The information processing apparatus according to claim 4, wherein the at least one processor is configured to execute the processing instructions to
calculate a sum of costs at stations and between stations responsive to a number of train cars operated at stations and between stations, in a group of the association information, and create the train car operation plan in such a manner as to minimize the sum of the costs.

6. The information processing apparatus according to claim 5, wherein
the more a train car is desired to be operated at a station and between stations, the smaller value the cost is set to.

7. The information processing apparatus according to claim 4, wherein the at least one processor is configured to execute the processing instructions to
construct the association information in which the cost incurred for each train car due to operation at a station and between stations is associated with the station information.

8. The information processing apparatus according to claim 7, wherein the at least one processor is configured to execute the processing instructions to
receive an operation request concerning a train car between stations, and construct the association information in which the cost responsive to the operation request is associated with the station information.

9. An information processing method comprising, by an information processing apparatus:
constructing association information in which a constraint on a number of train cars at a station and between stations is associated with station information representing a station at each time, based on a train schedule; and
creating a train car operation plan in which a train formation operated at a station and between stations in the train schedule is defined in such a manner as to satisfy the constraint, based on the association information.

10. The information processing method according to claim 9 comprising, by the information processing apparatus,
creating a graph in which the station information is a node and an edge representing the constraint is connected to the node, as the association information.

11. The information processing method according to claim 10 comprising, by the information processing apparatus,
creating the graph in which a constraint on a number of train cars of a train formation waiting at a station and a number of train cars of a train moving between stations is connected as the edge to the node.

12. The information processing method according to claim 9 comprising, by the information processing apparatus,
calculating a cost at a station and between stations responsive to a number of train cars operated at a station and between stations in the train schedule, based on the association information, and creating the train car operation plan based on the calculated cost.

13. The information processing method according to claim 12 comprising, by the information processing apparatus,
calculating a sum of costs at stations and between stations responsive to a number of train cars operated at stations and between stations, in a group of the association information, and creating the train car operation plan in such a manner as to minimize the sum of the costs.

14. The information processing method according to claim 13, wherein
the more a train car is desired to be operated at a station and between stations, the smaller value the cost is set to.

15. The information processing method according to claim 12 comprising, by the information processing apparatus,
constructing the association information in which the cost incurred for each train car due to operation at a station and between stations is associated with the station information.

16. The information processing method according to claim 15 comprising, by the information processing apparatus,
receiving an operation request concerning a train car between stations, and constructing the association information in which the cost responsive to the operation request is associated with the station information.

17. A non-transitory computer-readable storage medium storing a program, the program comprising instructions for causing an information processing apparatus to execute processes to:
construct association information in which a constraint on a number of train cars at a station and between stations is associated with station information representing a station at each time, based on a train schedule; and
create a train car operation plan in which a train formation operated at a station and between stations in the train schedule is defined in such a manner as to satisfy the constraint, based on the association information.
